(19) United States
(12) Patent Application Publication
(10) Pub. No.: US 2024/0042625 A1
(43) Pub. Date: Feb. 8, 2024

(54) AUTO EJECTING VACUUM TIP

(71) Applicant: ClearPoint Neuro, Inc., Solana Beach, CA (US)

(72) Inventor: Nathan Williams, San Diego, CA (US)

(21) Appl. No.: 18/364,883

(22) Filed: Aug. 3, 2023

Related U.S. Application Data
(60) Provisional application No. 63/394,720, filed on Aug. 3, 2022.

(51) Int. Cl. B25J 15/06; B65G 47/91

(52) U.S. Cl. CPC B25J 15/0616; B65G 47/91

(57) ABSTRACT

A pick head system includes a pick head having a tip through which a vacuum-assisted force can be applied to pick up an object at the tip of the pick head. The pick head has an internal lumen that forms a tip opening at the tip of the pick head. A housing of the pick head has an internal shaft in which the pick head is positioned. The system can be actuated to achieve relative movement between the pick head and the housing and transition the pick head between a retracted state that applies the vacuum-assisted force for picking up an object and an extended state that interrupts the vacuum-assisted force to release the object.

### CROSS-REFERENCE TO RELATED APPLICATION

The present application claims priority to U.S. Provisional Patent Application Ser. No. 63/394,720, filed Aug. 3, 2022, entitled “AUTO EJECTING VACUUM TIP,” the full disclosure of which is incorporated herein by reference.

### BACKGROUND

A vacuum device is sometimes used to pick up and hold objects such as in the context of a medical device. One common example is a ‘vacuum pick’ or ‘vacuum pen’ tool, which has a head or tip through which a vacuum enabled pickup force is used to attach an object to the tip of the tool. The vacuum can then be interrupted or reversed to release the object. The vacuum can be adjusted by a variety of mechanisms including for example buttons, switches, plungers or valves.

### SUMMARY

In the context of a vacuum pick, it may be desirable for the tip/head of the vacuum pick to move, rotate, or otherwise actuate to enable variations in placement of the object or dropping the object that is attached to the tip of the vacuum pick via vacuum. For example, surface mount technology (SMT) pick and place machines typically have a plurality of vacuum-assisted heads that move up and down to place the objects onto a circuit board. The vacuum is typically released to thereby release the attached object from the vacuum pick once the tip of the vacuum pick is lowered and the object is in the desired position.

Disclosed herein are systems and methods for controlling a vacuum pick (also referred to as a pick head) such as pursuant to application of a vacuum assisted pickup force to automatically interrupt the vacuum and to instead apply pressure so that an object is ejected when the pick head is actuated.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

FIG. 1 shows a schematic illustration of a vacuum assisted pickup tool.

FIG. 2A shows a schematic illustration of a vacuum assisted pick head.

FIG. 2B shows a partial transparent view of the pick head.

FIG. 3 shows the pick head inside a housing.

FIGS. 4 and 5 show the pick head in different states of actuation.

FIG. 6 shows another embodiment of the vacuum assisted pick head.

FIGS. 7 and 8 show yet another embodiment of the vacuum assisted pick head.

FIGS. 9-11 shows yet another embodiment of the vacuum assisted pick head.

FIG. 12 shows an embodiment wherein a housing moves relative to a pick head to actuate between an extended state and a retracted state.

### DETAILED DESCRIPTION

Before the present subject matter is further described, it is to be understood that this subject matter described herein is not limited to particular embodiments described, as such may of course vary. It is also to be understood that the terminology used herein is for the purpose of describing particular embodiments only, and is not intended to be limiting. Unless defined otherwise, all technical terms used herein have the same meaning as commonly understood by one skilled in the art to which this subject matter belongs.

Disclosed herein are systems and methods for actuating or otherwise controlling the application of a vacuum assisted pickup force of a pick head tool. The system is configured to automatically interrupt the vacuum assisted pickup force and to instead apply pressure (such as an outwardly directed pressure) so that an object is ejected via the pressure when the pick head is actuated.

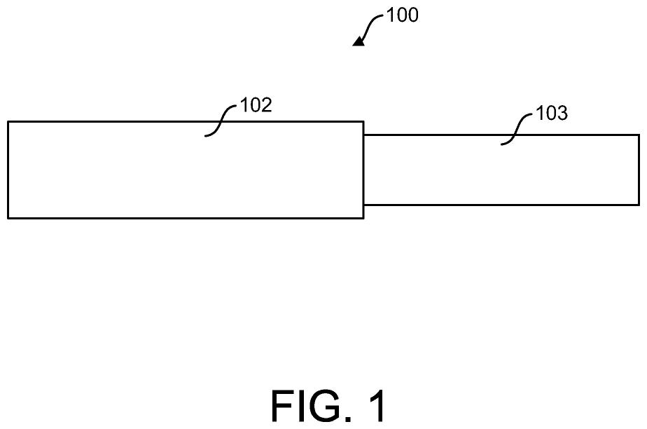

FIG. 1 shows a schematic illustration of a vacuum assisted pickup tool 100. The configuration of the pickup tool 100 can vary. The pickup tool 100 may be an elongated body such as a pen-like configuration. Or the pickup tool 100 may be a component that mounts onto a machine such as a pick and place machine. In the illustrated embodiment, the pickup tool has a proximal handle region 102 that can be grasped in a hand of a user and a distal region 103 that has an opening through which a vacuum-assisted force can be used to attach an object to be picked up or otherwise attached and manipulated. Various embodiment of the pickup tool including the pick head portion of the pickup tool are described herein. The pick head portion can be located or otherwise incorporated into the distal region 103 of the pickup tool 100. It should be appreciated that the size and shape of the pickup tool can vary and is not limited to the sizes and shapes described herein.

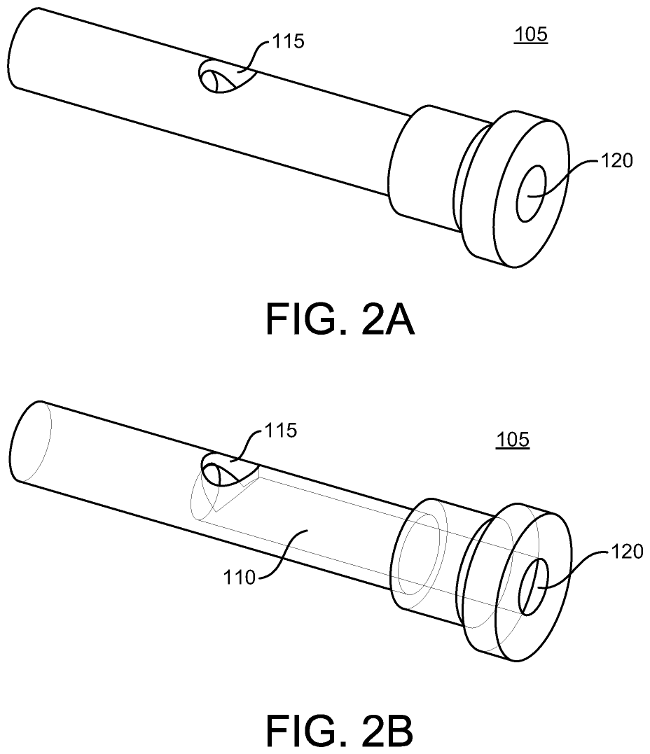

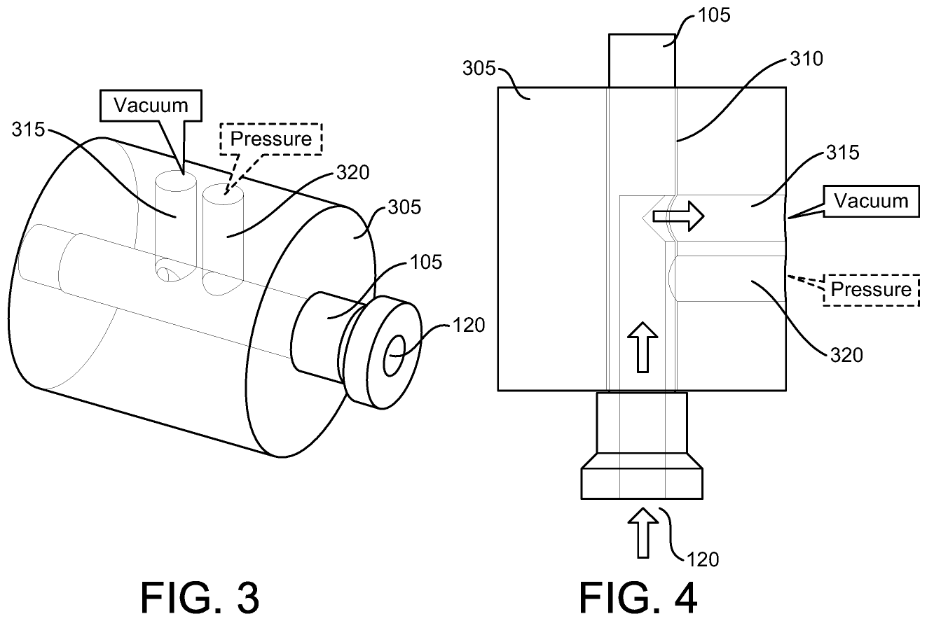

FIG. 2A show a schematic illustration of a vacuum assisted pick head 105. FIG. 2B shows a partial transparent view of the head 105, which is formed of an elongated body having an internal lumen 110. As mentioned, the pick head 105 can be part of the pickup tool 100 such as removably attached thereto or part of a common housing. The internal lumen 110 forms an opening or port 115 positioned along a side region (or other location) of the elongated body. The internal lumen 110 can terminate (along its axis) at a proximal end at the location of the port 115. In another embodiment, the internal lumen continues proximally past the port 115. The internal lumen 110 also forms a tip opening 120 at a tip (such as a distal tip) of the elongated body. The port 115, lumen 110, and tip opening 120 collectively form a mechanism through which a vacuum-assisted force can be used to grab an object at the tip of the pick head 105.

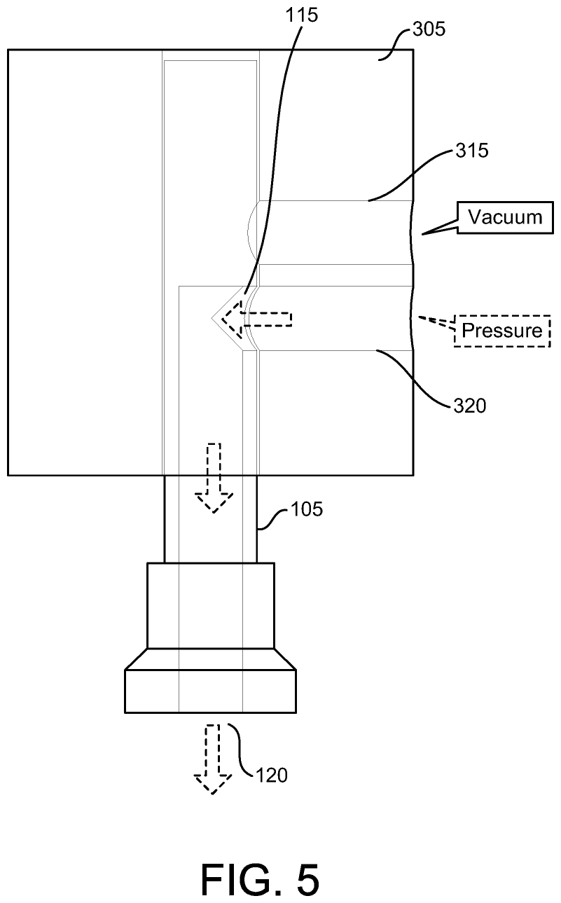

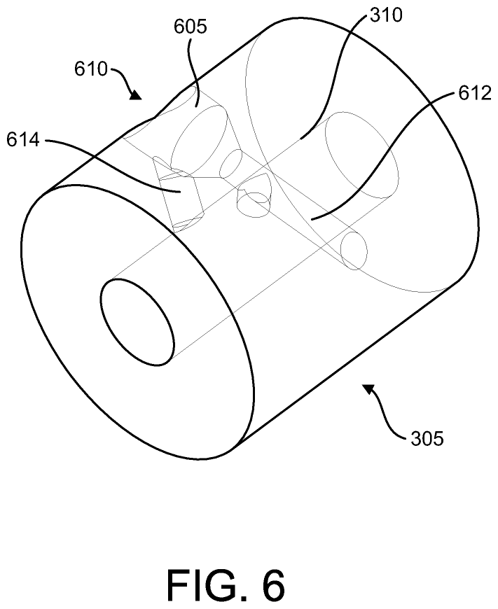

FIGS. 3 and 4 show the pick head 105 positioned within a housing 305 to collectively form a portion of the pickup tool 100. The pick head 105 is slidably positioned within an internal shaft 310 (FIG. 4) or chamber of the housing 305. The pick head 105 can be actuated to move between a retracted position and an extended position via relative movement between the pick head 105 and the housing 305. For clarity of illustration, the figures show the housing 305 as a cylindrical body although it should be appreciated that the housing 305 can vary in size and shape.

The housing 305 includes a vacuum channel 315 and a high-pressure (relative to vacuum) channel 320 that are spaced from one another. The vacuum channel 315 is a passageway that at one end communicates with the internal shaft 310 and at another end (or region) communicates with a vacuum source. The high-pressure channel 320 is a passageway that communicates at one end with the internal shaft 310 and at another end or region with a high pressure source. The pick head 105 can be actuated (via relative movement of the pick head 105 within the internal shaft 310) to selectively align the port 115 (FIG. 1) of the pick head 105 with either the vacuum channel 315 or the high-pressure channel 320. Movement of the pick head 105 can be achieved in various manners including via manual grasping by a user or by an automated mechanism.

In a retracted state, the port 115 aligns with the vacuum channel 315 (as shown in FIGS. 3 and 4) so that a vacuum-assisted pickup force is achieved at the tip of the pick head 105. That is, the vacuum source provides at the opening 120 an inwardly directed vacuum-assisted force via the vacuum channel 315, the port 115, the internal lumen of the pick head 105, and the tip opening 120 of the pick head 105. In an extended state, the port 115 aligns with the high-pressure channel 320 so that an outwardly directed ejection force is achieved at the tip of the pick head 105. That is, the high pressure source provides the outwardly directed ejection force via the high-pressure channel 320, the port 115, the internal lumen of the pick head 105, and the tip opening 120 of the pick head 105. One or more seals can be positioned on the port 115 or at the location(s) where the port 115 aligns with the channels 315/320 to provide a sealed relationship between the port 115 and the respective channels.

FIGS. 3 and 4 show the pick head 105 in the retracted position such that the port 115 aligns with the vacuum source. As mentioned, the port 115 of the pick head 105 communicates with the vacuum channel 315. This results in a vacuum at the tip opening 120 of the pick head 105. Thus, the pick head 105 can hold an object via the vacuum at the tip opening 120.

FIG. 5 shows the pick head 105 in the extended position within the housing 305. The port 115 communicates with the high-pressure channel 320. The tip opening 120 thus has a high-pressure that generates an outward force at the opening 120 to release or eject the object. FIG. 5 shows the port 115 on the pick head 105 is fully aligned with the pressure channel 320 on the housing 305. The system may be configured to vary the size of the channel 320 to so that the port 115 can be configured to selectively align with the channel either in a fully aligned position or in a partially aligned position. In this manner ejection (i.e., venting) does not begin until the pick head is in the fully extended position.

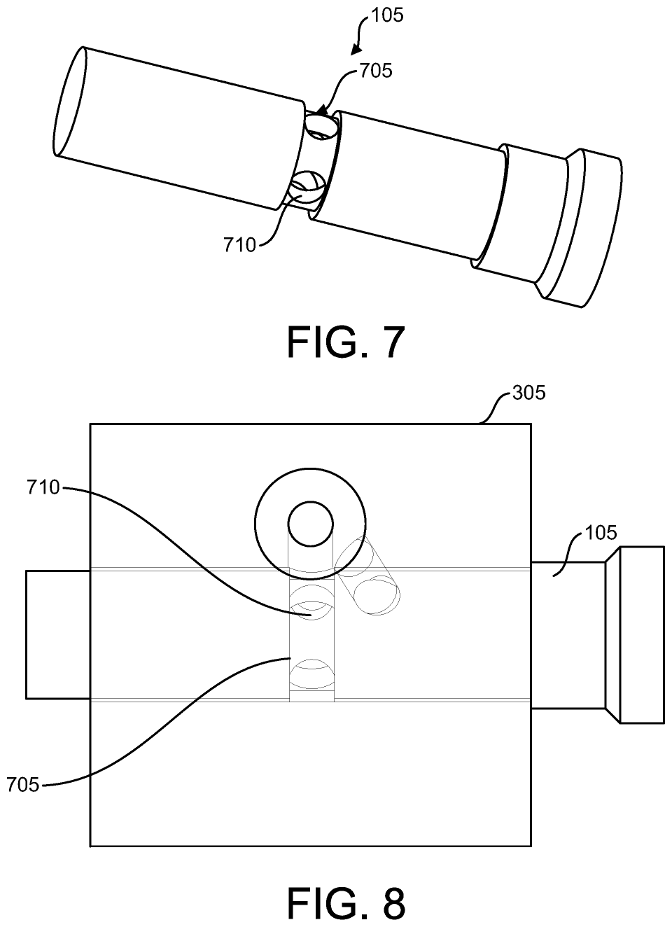

FIG. 6 shows an embodiment of the housing 305 that utilizes only a single channel 605 to provide both vacuum and high pressure to the pick head 105, which can be mounted within the housing 305. The single channel 605 branches into two separate channels within the housing including a Venturi passageway 612 and a high pressure channel 614. The Venturi passageway is a passageway having a constricted region or choke region such that fluid flow therethrough achieves the Venturi effect (i.e., a reduction in pressure.) The Venturi passageway is defined within the housing 305.

The housing 305 thus has a single channel 605 (which can be a high pressure channel) that communicates with a source of pressure via a single port 610 in the housing 305. The housing further includes the Venturi passageway 612 (a passageway of reduced diameter) that communicates with the single channel 605 to utilize the Venturi effect to create a vacuum force. The Venturi effect is the reduction in fluid pressure that results when a fluid flows through a constricted section (or choke) of a passageway such as through the passageway 612. The housing also includes a channel 614 that communicates with the port 610 and the shaft 310 to provide high pressure for ejection. Thus, the single input port 610 supplies both the vacuum and the high pressure.

Any embodiment described herein can include an exhaust port that communicates with the internal shaft 310 for removal of exhaust. The exhaust port can include a one-way valve that selectively restricts fluid flow either into or out of the internal shaft 310. In addition, a bladder, a piston or other element can be included in the pick head or other part of the system to limit flow when the pick head is in the extended state for ejection of the part.

In an embodiment the pick head has a specific shape, such as a key shape, that is configured to maintain a specific orientation relative to the port(s) and channel(s) of the housing. That is, the pick head can have a key shape that fits into a complementary key shape of the internal shaft so that the pick head can only be positioned in a predetermined orientation when in the internal shaft. The port(s) can then be located in specific locations of the pick head to correspond to the location of the vacuum channel and pressure channel to transition between a pickup and release state.

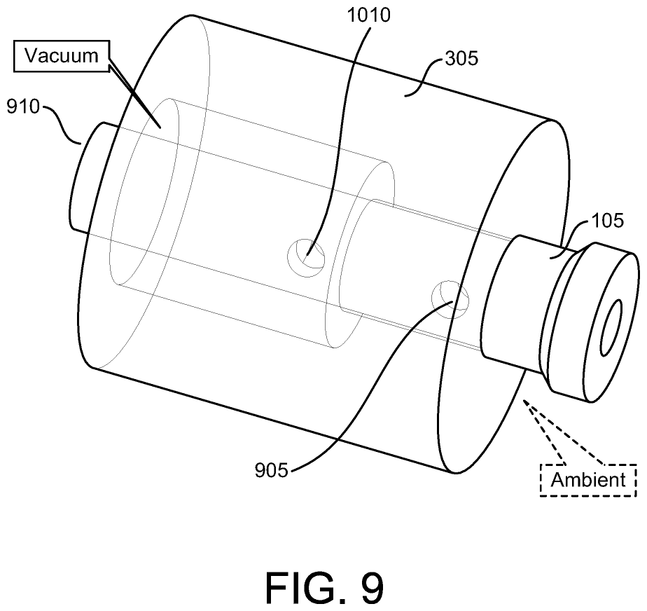

In an embodiment shown in FIG. 7, the pick head 105 includes two or more port holes and/or a channel on an external surface of the pick head. The pick head 105 shown in FIG. 7 includes an annular, circumferential slot or channel 705 that extends around an outer surface of the pick head 105. Two or more port holes 710 are dispersed along the channel 705 such as around the circumference of the channel 705 wherein the ports or holes 710 communicate with the internal lumen of the pick head 105. As shown in FIG. 8, when positioned in the housing 305, the pick head 105 can be positioned so that at least one port hole 710 of the collection of port holes aligns with a port on the housing 305. The pick head 105 is slidably and rotatably positioned in a tubular passageway of the housing 305 so that the port holes 705 of the pick head 105 can be aligned with the port on the housing to permit vacuum or high pressure communication therethrough. The pick head 105 can rotate about its long axis within the channel of the housing in which the pick head 105 is positioned. In this manner, at least one port of the plurality of ports of the channel 705 can align with a vacuum channel of the housing as the pick head rotates.

Some embodiments described above describe a channel/port dedicated to vacuum and a channel/port dedicated to high-pressure. In an alternate embodiment, the system includes only a single channel which is entirely dedicated to vacuum. The pick head can be configured to be movingly actuated to partially interrupt or break the vacuum, but it does not include a mechanism to completely break or vent the vacuum. Rather, vacuum can still be maintained and stay connected but can be sufficiently disrupted so that the object is released from the pick head.

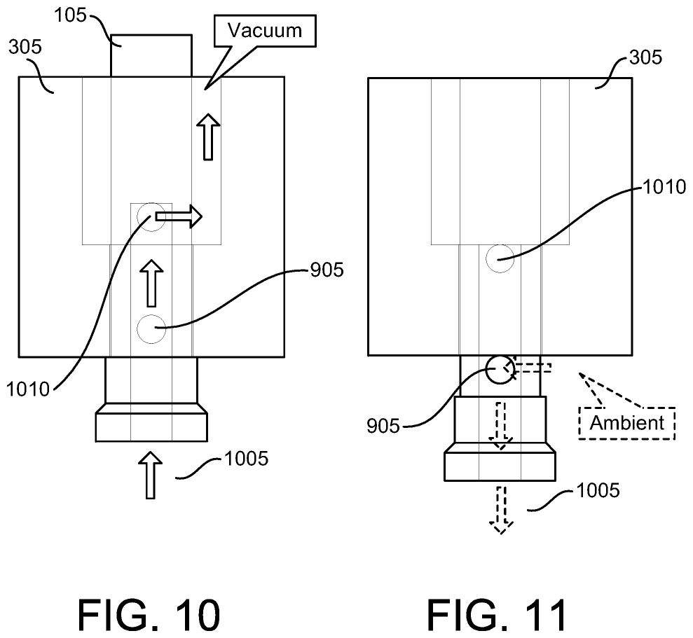

FIGS. 9, 10, and 11 show another embodiment. This embodiment uses ambient pressure to break the vacuum without applying or requiring high-pressure to eject the part attached to the pick head. The pick head 105 includes a channel 905 that can be opened or exposed to ambient pressure to thereby expose the internal lumen 110 of the pick head to ambient pressure. In this configuration the housing 305 has an internal vacuum chamber 910 that is under vacuum pressure. The vacuum chamber 910 at least partially surrounds a region of the pick head 105.

FIG. 10 shows the system with the pick head 105 in a retracted state. The internal lumen of the pick head 105 is exposed to the vacuum chamber 910 via an opening 1010 and thus under vacuum. This creates a vacuum force 1005 at the tip. FIG. 11 shows the system in the extended state. The channel 905 is exposed to ambient pressure. This permits the vacuum to be released due to the exposure of the channel 905 and internal lumen of the pick head to ambient pressure. This releases the vacuum force or creates an ejection force 1105.

Although the figures show circular channels and ports it should be appreciated that the shapes shown can vary widely including the shape of the pick head and the housing. Various shapes may be used to precisely control the flow rate and position of the pick head. For example, a large, flat slot may be used to break vacuum precisely when the pick head is fully extended. In another embodiment, an elongated port on the pick head is used to maintain connection to the vacuum channel while the pick head begins actuating.

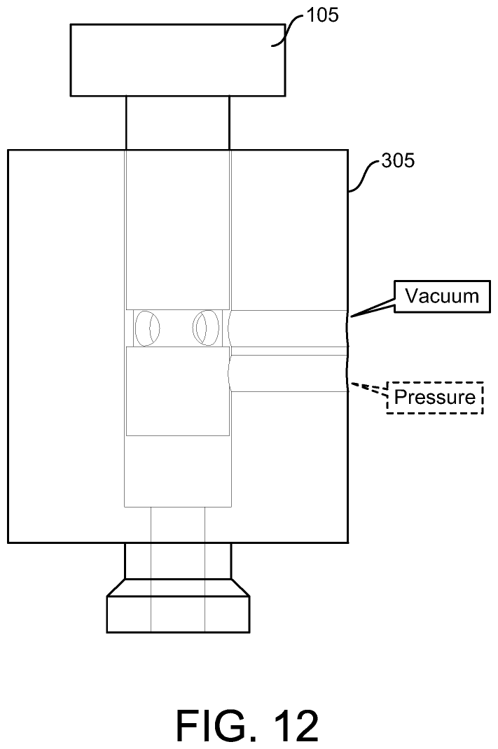

The aforementioned embodiments showed the pick head moving or otherwise actuating while the housing is stationary. It should be appreciated that relative movement between the pick head and housing can vary. For example, FIG. 12 shown an embodiment wherein the pick head 105 stays stationary while the housing 305 moves relative to the pick head 105 to actuate between the retracted state and the extended state.

While this specification contains many specifics, these should not be construed as limitations on the scope of an invention that is claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results. Only a few examples and implementations are disclosed. Variations, modifications and enhancements to the described examples and implementations and other implementations may be made based on what is disclosed.

1. A pick head system, comprising:
a pick head having a tip through which a vacuum-assisted force can be applied to pick up an object at the tip of the pick head, the pick head having an internal lumen that forms a tip opening at the tip of the pick head;
a housing having an internal shaft in which the pick head is positioned, wherein the system can be actuated to achieve relative movement between the pick head and the housing and transition the pick head between a retracted state that applies the vacuum-assisted force for picking up an object and an extended state that interrupts the vacuum-assisted force to release the object.

2. The system of claim 1, wherein the relative movement comprises the pick head moving relative to a stationary housing.

3. The system of claim 1, wherein the relative movement comprises the housing moving relative to a stationary pick head.

4. The system of claim 1, wherein the pick head is an elongated body positioned within the internal shaft.

5. The system of claim 1, wherein the housing has a vacuum shaft or chamber that aligns with a port in the pick head when the pick head is in the retracted state such that the vacuum shaft communicates with the tip opening of the tip head via the internal lumen of the pick head, and wherein the vacuum shaft communicates with a vacuum pressure source.

6. The system of claim 5, wherein the housing further has a high-pressure shaft or chamber that aligns with a port in the pick head when the pick head is in the extended state such that the high-pressure shaft communicates with the tip opening of the tip head via the internal lumen of the pick head, and wherein the high-pressure shaft communicates with a high pressure source.

7. The system of claim 1, wherein the housing includes a Venturi passageway that can be positioned to communicate with a port in the pick head.

8. The system of claim 1, wherein the pick head is key-shaped such that the pick head can be positioned within the internal shaft when aligned with a complementary key-shape of the internal shaft.

9. The system of claim 1, wherein the pick head has a circumferential channel that extends around on an outer surface of the pick head.

10. The system of claim 9, wherein a plurality of ports are positioned in the circumferential channel.

11. The system of claim 9, wherein the pick head can rotate within the internal shaft housing of the housing.

12. The system of claim 11, wherein at least one port of the plurality of ports can align with a vacuum channel of the housing as the pick head rotates.

13. The system of claim 1, wherein the housing further has a shaft or chamber connected to ambient pressure, wherein the shaft aligns with a port in the pick head when the pick head is in the extended state.

14. The system of claim 1, wherein the pick head includes a lumen exposed to ambient pressure in the extended state to interrupt the vacuum-assisted force to release the object.
